(19) United States
(12) Patent Application Publication
(10) Pub. No.: US 2016/0156567 A1
(43) Pub. Date: Jun. 2, 2016

(54) ALLOCATION METHOD OF A COMPUTER RESOURCE AND COMPUTER SYSTEM

(71) Applicant: HITACHI, LTD., Tokyo (JP)

(72) Inventors: Hideyuki MIYAHARA, Tokyo (JP); Ryoichi UEDA, Tokyo (JP)

(73) Assignee: HITACHI, LTD., Tokyo (JP)

(21) Appl. No.: 14/635,538

(22) Filed: Mar. 2, 2015

(30) Foreign Application Priority Data
Nov. 28, 2014 (JP) 2014-241535

(51) Int. Cl. H04L 12/911; H04L 29/08; H04L 12/46

(52) U.S. Cl. CPC H04L 47/70; H04L 12/4641; H04L 67/1002

(57) ABSTRACT

A method of allocating a computer resource, for dynamically changing a virtual machine group in a computer system, the method comprising: acquiring, by a management computer, performance of the virtual machine group for providing the service; comparing, by the management computer, the acquired performance of the virtual machine group with a performance condition for the service set in advance; determining, by the management computer, the computer resource to be changed within the virtual machine group in accordance with a result of the comparison; measuring, by the management computer, performance of the virtual machine by conducting a trial run of the service on the virtual machine corresponding to the computer resource to be changed; determining, by the management computer, whether or not the measured performance satisfies the performance condition for the service; and applying, by the management computer, the change when the measured performance satisfies the performance condition for the service.

### CLAIM OF PRIORITY

The present application claims priority from Japanese patent application JP 2014-241535 filed on Nov. 28, 2014, the content of which is hereby incorporated by reference into this application.

### BACKGROUND

This invention relates to a computer system capable of dynamically changing a computer resource to be allocated to a service.

In recent years, a cloud computing technology has been developed and a cloud service has been provided. Therefore, an environment in which a user of a service only needs to manage a system at a higher level than an operating system or middleware without the need to manage hardware has almost been established.

Cloud systems include such a public cloud as represented by Amazon Web Services (AWS), a private cloud, and a federated cloud obtained by combining one of such clouds and an on-premise system, and are implemented by wide-ranging configuration methods.

It is conceivable that in the future, there may be an increasing number of requests to select an optimum configuration in terms of performance and cost from among wide-ranging configuration patterns of cloud systems. In addition, while there are services whose demand is predictable to some extent, the demand for Web services and the like is hard to predict, which raises a large number of requests to change system performance dynamically in response to the demand.

JP 2013-513139 A relates to a technology for sharing a computer resource between cloud infrastructures or between cloud providers within a cloud system. In JP 2013-513139 A, there is disclosed a technology in which a service running on a cloud system including no surplus computer resource acquires a new computer resource from another cloud provider.

### SUMMARY

It is often the case that a plurality of services run in a cloud system. In other cases, a plurality of users sometimes share the same computer resource in the cloud system. The user can learn the performance of the cloud system by referring to a catalog publicized by each cloud provider, but the cloud system generally has no guaranteed performance, and actual performance may greatly vary depending on when the computer resource is acquired.

In this respect, different physical resources are sometimes allocated in actuality even with the same performance on the catalog. In other cases, another process sharing the same computer resource may excessively use a CPU, a memory, a disk, a network, and the like, which may reduce the performance to a lower level than specifications on the catalog with the actually allocated computer resource. Those are recognized widely as a problem in that the performance is not guaranteed in the cloud system.

Therefore, this invention has been made in view of the above-mentioned problem, and it is an object thereof to provide an appropriate computer resource in a cloud system while suppressing reduction in performance thereof.

A representative aspect of the present disclosure is as follows. A method of allocating a computer resource, for dynamically changing a virtual machine group in a computer system, the computer system comprising: a physical computer comprising a processor and a memory; a virtualization module for allocating a computer resource of the physical computer to a virtual machine; a management computer for controlling the virtual machine group of at least one virtual machine for providing a service, the method comprising: a first step of acquiring, by the management computer, performance of the virtual machine group for providing the service; a second step of comparing, by the management computer, the acquired performance of the virtual machine group with a performance condition for the service set in advance; a third step of determining, by the management computer, the computer resource to be changed within the virtual machine group in accordance with a result of the comparison; a fourth step of measuring, by the management computer, performance of the virtual machine by conducting a trial run of the service on the virtual machine corresponding to the computer resource to be changed; a fifth step of determining, by the management computer, whether or not the measured performance satisfies the performance condition for the service; and a sixth step of applying, by the management computer, the change when the measured performance satisfies the performance condition for the service.

According to one embodiment of this invention, it is possible to handle increase/decrease in load dynamically while providing an optimum computer resource in terms of cost and performance.

### BRIEF DESCRIPTION OF THE DRAWINGS

FIG. 1A is a block diagram illustrating a schematic diagram of a cloud system according to a first embodiment of this invention.

FIG. 1B is a block diagram illustrating an example of the cloud infrastructure according to the first embodiment of this invention.

FIG. 2 is a block diagram illustrating details of the management server according to the first embodiment of this invention.

FIG. 3 is a flowchart illustrating an example of processing for increasing the allocated computer resources executed by the management server according to the first embodiment of this invention.

FIG. 4 is a sequence diagram illustrating an example of the performance test executed in Step 304 according to the first embodiment of this invention.

FIG. 5A is a table showing an example of the performance log of the active system according to the first embodiment of this invention.

FIG. 5B is a table showing an example of the performance log of the VM set to be tested according to the first embodiment of this invention.

FIG. 6 is a table showing an example of the performance test result table for each instance according to the first embodiment of this invention.

FIG. 7 is a table showing an example of the SLA information according to the first embodiment of this invention.

FIG. 8 is a table showing an example of the VM performance information.

FIG. 9 is a table showing the resource list for each data center according to the first embodiment of this invention.

FIG. 10 is a diagram illustrating an example of the request according to the first embodiment of this invention.

FIG. 11 is a diagram illustrating an example of a request pattern according to the first embodiment of this invention.

FIG. 12 is a block diagram illustrating an example of a configuration of the physical computer according to the first embodiment of this invention.

FIG. 13 is an input screen output by the display content generation module according to the first embodiment of this invention.

FIG. 14 illustrates a modification example of the first embodiment, and is a block diagram illustrating an example of functions of the cloud system.

### DETAILED DESCRIPTION OF THE PREFERRED EMBODIMENTS

Now, embodiments of this invention are described with reference to the accompanying drawings.

### First Embodiment

This invention relates to a technology for enhancing and reducing a computer resource to be allocated dynamically in response to a request received from a user for a task system (or client system) configured on a single or a plurality of cloud systems, and to an infrastructure therefor. Through use of the cloud system, a service can handle increase/decrease in request dynamically while acquiring an optimum computer resource based on cost and performance from among a single or a plurality of cloud infrastructures (or data centers).

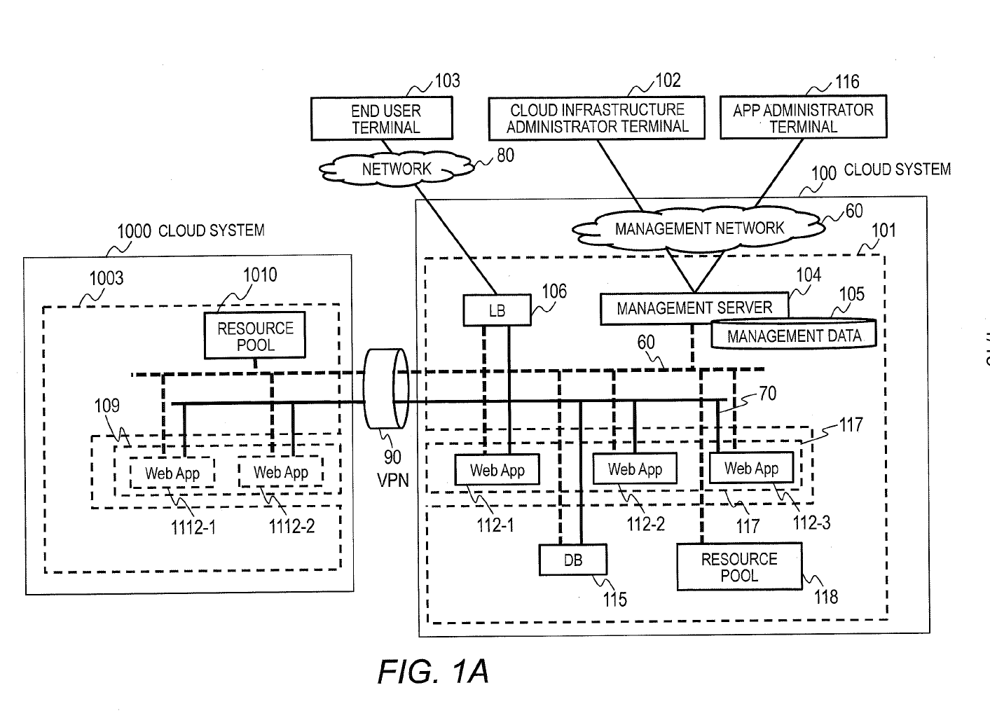

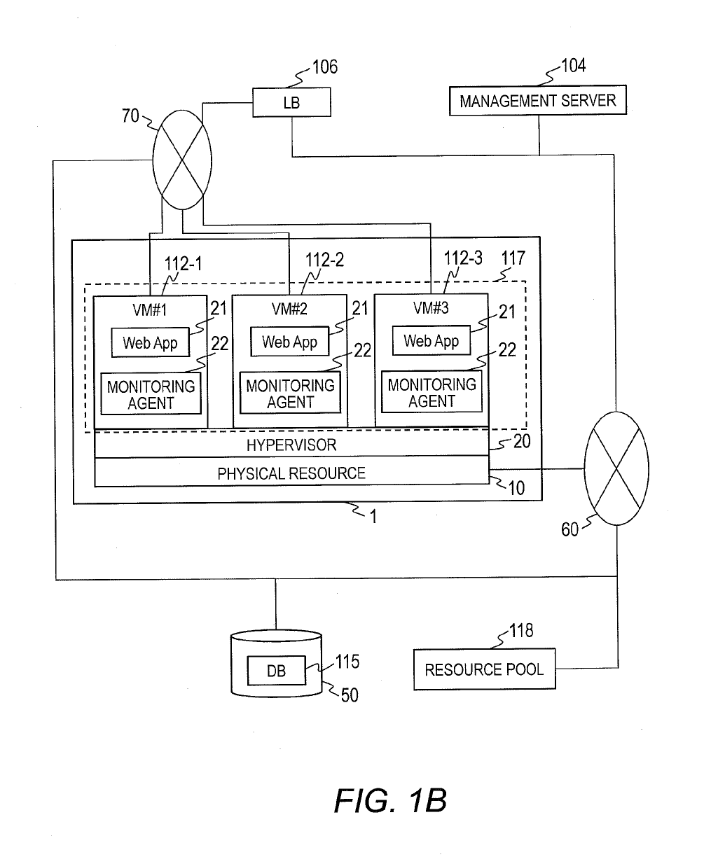

FIG. 1A is a block diagram illustrating a schematic diagram of a cloud system to which this invention is applied. Cloud systems 100 and 1000 are computer systems including a plurality of virtual machines (VMs). It should be noted that the cloud systems 100 and 1000 do not limit the scope of configurations and functions described in this specification.

The cloud system 100 forms a first data center, and the cloud system 1000 forms a second data center. The cloud system 100 and the cloud system 1000 are placed at geographically different locations, or can be placed in different buildings, on different floors, or the like.

Between the cloud system 100 and the cloud system 1000, a cloud infrastructure 101 and a cloud infrastructure 1003 are coupled to each other through a virtual private network (VPN) 90, and the cloud system 100 and the cloud system 1000 can be accessed as one network.

The cloud system 100 is coupled to an end user terminal 103 through an external network 80. The cloud system 100 is coupled to a cloud infrastructure administrator terminal 102 and an app administrator terminal 116 through a management network 60.

A central part of the cloud system 100 is configured by the cloud infrastructure 101. The cloud infrastructure 101 is managed by the cloud infrastructure administrator terminal 102. The cloud infrastructure 101 includes, as components thereof, a management server 104, management data 105, a resource pool 118, a load balancer 106, and a database (“DB” in the drawings) 115.

Further, the cloud system 100 includes a virtual machine (VM) set 117 allocated from the resource pool 118. The VM set 117 includes Web App servers 112-1 to 112-3 for providing a service based on a Web application (“Web App” in the drawings) generated by the app administrator terminal 116. It should be noted that the Web App server is collectively represented by a reference numeral “112” without appending a suffix thereto. Further, the same applies to other components, which are collectively represented by reference numerals without appending a suffix thereto.

Further, at least one virtual machine group (Web App servers 112-1 to 112-3) that provides the service to the end user terminal 103 is set as an active system or the client system.

The load balancer 106, the Web App servers 112, and the database 115 are coupled to a task network 70 and the management network 60. The management server 104, the resource pool 118, the cloud infrastructure administrator terminal 102, and the app administrator terminal 116 are coupled only to the management network 60.

Those Web App servers 112 are coupled to the network 80 through the load balancer (“LB” in the drawings) 106. A request transmitted from the end user terminal 103 is received by the load balancer 106 through the network 80, and is distributed to each of the Web App servers 112-1 to 112-3.

The database 115 stores data on the service to be used by the Web application, and is coupled to the Web App servers 112.

A monitor agent for performance measurement and acquisition of a use status of a resource runs on each of the load balancer 106 and the Web App servers 112. A log of the monitor agent on each of the Web App servers 112 and the load balancer 106 is transmitted to the management server 104 and accumulated in the management data 105.

As described later, the management server 104 executes a performance test of a virtual machine forming the client system before enhancing or reducing the virtual machine to be allocated to the Web App server 112. Then, as a result of the performance test, the management server 104 selects the virtual machine that satisfies a predetermined performance condition, to dynamically add or delete the virtual machine.

As a function for measuring performance, the load balancer 106 has a function of, when the above-mentioned performance test is started, copying the request received from the end user terminal 103 at random and distributing the request to the VM to be subjected to the performance test. When all the requests are selected at random to copy HTTP requests, it is conceivable that the load balancer 106 selects the requests at random while maintaining an HTTP session.

In addition, the load balancer 106 has a function of measuring an average response time for the request received from the end user terminal 103 and transmitting the average response time to the management server 104. The load balancer 106 also has a function of transmitting the copied request to the management server 104 in order to accumulate the request received from the end user terminal 103.

The database 115 needs to have a function that prevents inconsistency from occurring during the performance test. In the database 115, a snapshot is used. Read or write access that occurs in the performance test is processed by the snapshot of the database 115, to thereby prevent data inconsistency from occurring on an actual environment.

The resource pool 118 is computer resources including a CPU, a memory, and a disk for generating a new virtual machine (VM). The resource pool 118 is coupled to the management server 104, and receives an instruction to, for example, generate or delete the VM from the management server 104, and a hypervisor generates or deletes the VM.

The cloud system 1000 coupled to the cloud system 100 includes, in the cloud infrastructure 1003, a resource pool 1010 and a VM set 109 including virtual machines 1112-1 and 1112-2.

FIG. 1B illustrates a first embodiment of this invention, and is a block diagram illustrating an example of the cloud infrastructure 101. In the cloud infrastructure 101, a physical computer 1, the load balancer 106, the management server 104, the resource pool 118, and a storage 50 for storing the database 115 are coupled to one another through the management network 60. Further, the load balancer 106, a VM#1 (112-1), a VM#2 (112-2), and a VM#3 (112-3) that form the VM set 117, and the database 115 are coupled to one another through the task network 70.

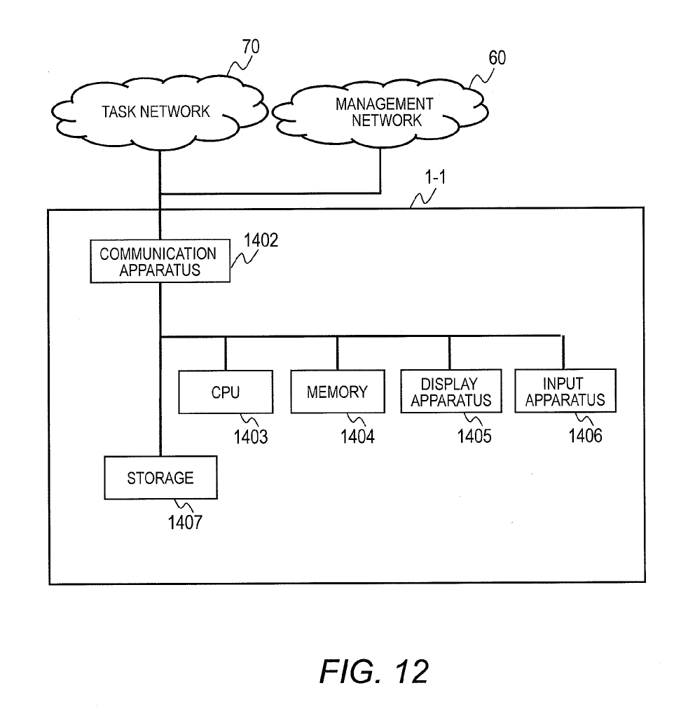

The physical computer 1 includes a physical resource 10 illustrated in FIG. 12 described later, a hypervisor (virtualization module) 20 that runs on the physical resource 10, and the VM set 117 that is formed of a plurality of virtual machines of the VM#1 to the VM#3 and that runs on the hypervisor 20.

A monitoring agent 22 for monitoring the performance and the computer resource and a Web application (“Web App” in the drawings) 21 run on each of the VM#1 to the VM#3. Therefore, the VM#1 to the VM#3 function as the Web App servers 112-1 to 112-3. The Web application 21 has functions of an HTTP server and an application server, and uses the database 115.

In the same manner as described above, the resource pool 118 includes a physical computer illustrated in FIG. 12 described later, a hypervisor (virtualization module) 20 that runs on the physical computer, and a plurality of virtual machines that run on the hypervisor 20.

Although not shown, in the same manner, the cloud system 1000 includes at least one physical computer and a plurality of virtual machines, and the virtual machines 1112-1 and 1112-2 that are unallocated are registered in the resource pool 1010 by the management server 104.

It should be noted that a virtual machine monitor (VMM) may be employed in place of the hypervisor 20.

FIG. 12 is a block diagram illustrating an example of a configuration of the physical computer 1. The physical computer 1 includes a communication apparatus 1402, a CPU 1403, a memory 1404, a display apparatus 1405, an input apparatus 1406, a storage 1407, and is coupled to the management network 60 and the task network 70.

This embodiment discusses an example in which the management server 104 and the load balancer 106 are configured by the same physical computer as illustrated in FIG. 12, but may be configured by a virtual machine. It should be noted that the virtual machines 1112-1 and 1112-2 of the cloud system 1000 also run on the same physical computer 1 as illustrated in FIG. 12. It should be noted that the CPU 1403 can be formed of a multicore processor.

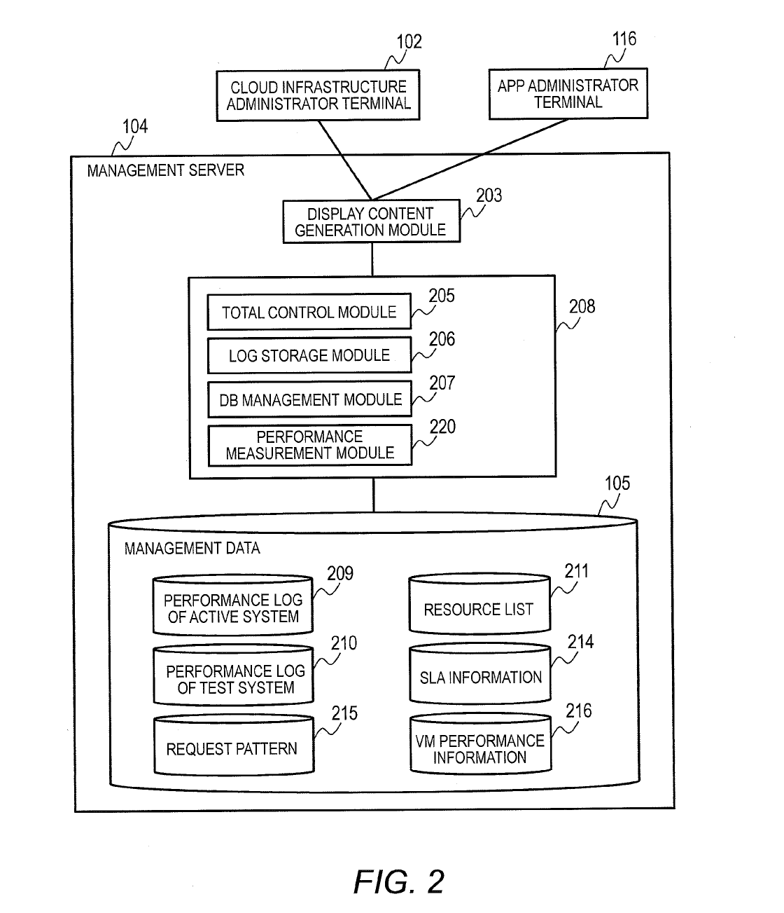

FIG. 2 is a block diagram illustrating details of the management server 104. The management server 104 includes a display content generation module 203, a control program 208, and the management data 105. The display content generation module 203 and the control program 208 are loaded into the memory 1404 illustrated in FIG. 12, to be executed by the CPU 1403.

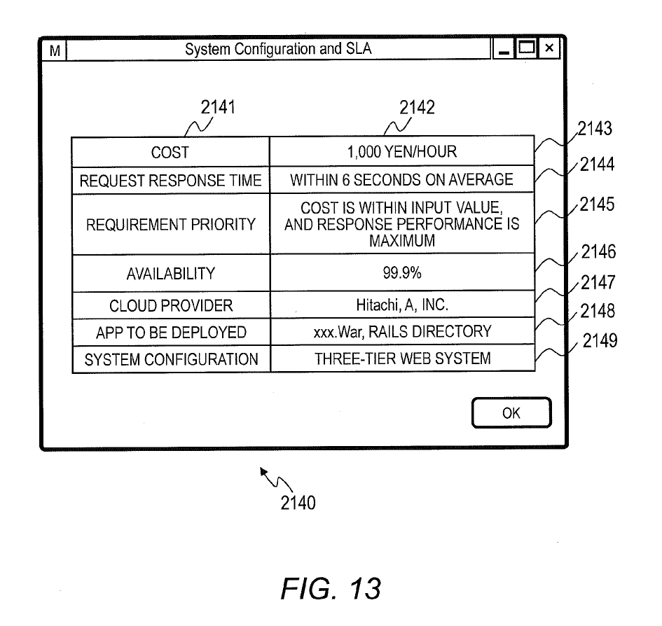

In the management server 104, the cloud infrastructure administrator terminal 102 and the app administrator terminal 116 are coupled to the display content generation module 203, and perform input/output processing. FIG. 13 illustrates an input screen 2140 output by the display content generation module 203.

The control program 208 includes a total control module 205, a log storage module 206, a DB management module 207, and a performance measurement module 220.

The total control module 205 has a function of cutting out the virtual machine from the resource pool 118 so as to satisfy an input determined by the app administrator terminal 116.

The log storage module 206 collects performance information such as a response time and the use status of the resource such as a VM size from the monitoring agent 22 that runs on an apparatus such as each of the Web App servers 112, the database 115, or the load balancer 106 under the management of the management server 104, and accumulates the performance information in a performance log 209 of the active system within the management data 105.

Further, the log storage module 206 acquires the request transmitted from the end user terminal 103 to the load balancer 106, and stores the request in a request pattern 215 within the management data 105. Alternatively, the load balancer 106 can transmit a replication of the request to the management server 104, and the log storage module 206 can acquire the replication and accumulate the replication in the request pattern 215. It should be noted that the performance log 209 of the active system is performance information obtained when the monitoring agent 22 that runs on the load balancer 106 acquires the performance information such as the response time of the Web App server 112. The load balancer 106 transmits the performance information to the management server 104, and the management server 104 accumulates the received performance information in the performance log 209 of the active system. It should be noted that the performance information is the performance information on the active system (client system).

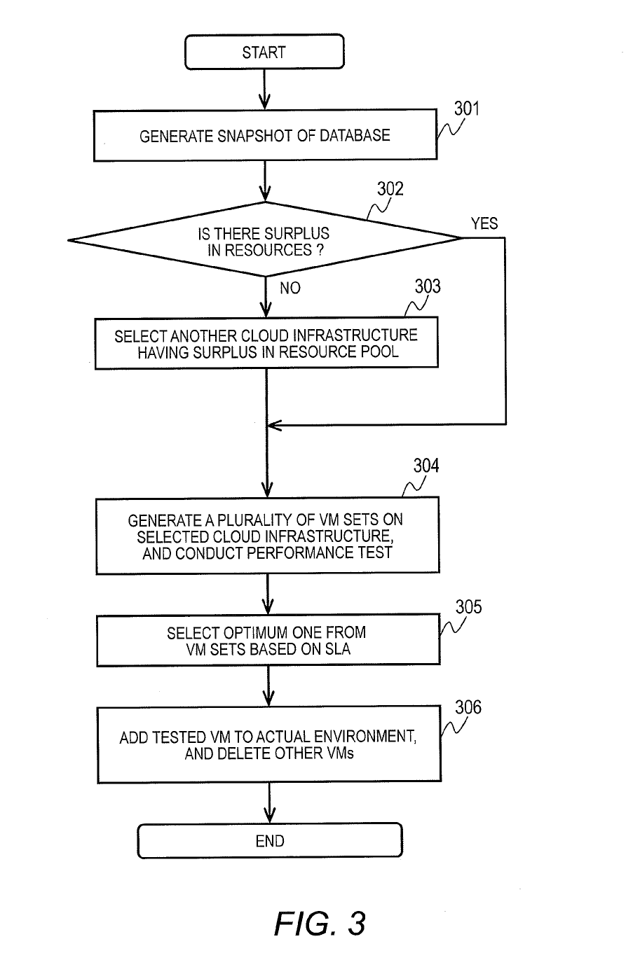

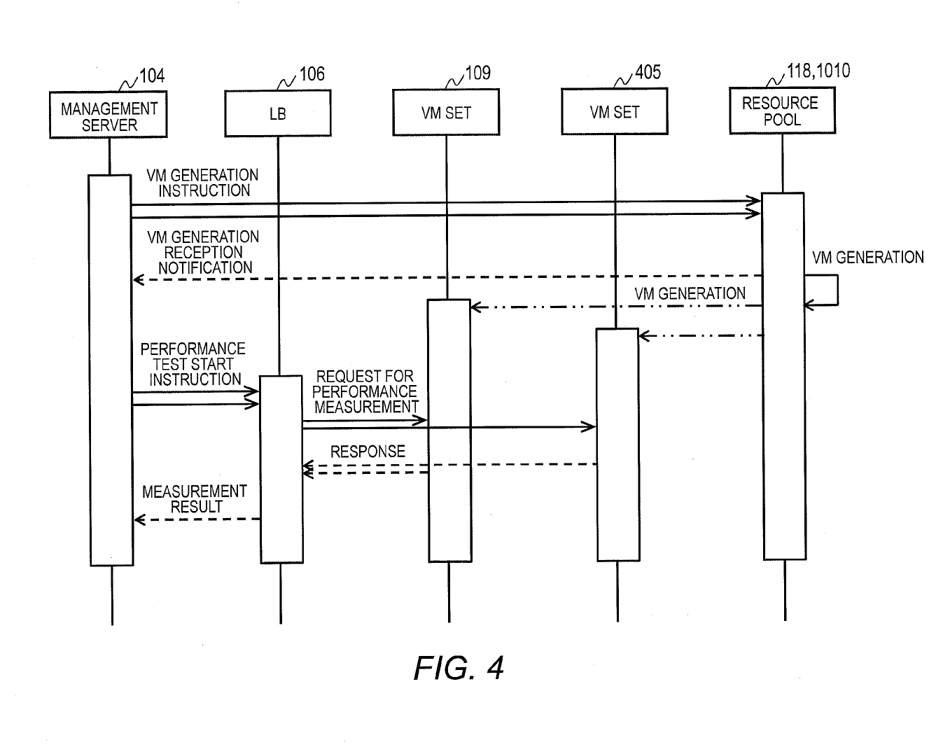

The DB management module 207 manages the database 115. In particular, in this invention, as illustrated in FIG. 3 and FIG. 4 described later, the virtual machine is subjected to the performance test, but the DB management module 207 has a function that prevents inconsistency from occurring in the active system during the performance test.

The performance measurement module 220 executes the performance test for the virtual machine (VM) generated when the cloud system 100 is enhanced or reduced. In this embodiment, the management server 104 generates a virtual machine for a test before the virtual machine to be allocated to the Web App server 112 is enhanced or reduced, and the performance measurement module 220 executes the performance test for the virtual machine for a test. Then, the management server 104 selects the virtual machine that satisfies service level agreement (SLA) information as a virtual machine to be enhanced or reduced from among the virtual machines for the test. It should be noted that the SLA information is operation information including the performance condition and a cost condition as described later.

The management data 105 includes the performance log 209 of the active system, a performance log 210 of a test system, a resource list 211, SLA information 214, the request pattern 215, and VM performance information 216.

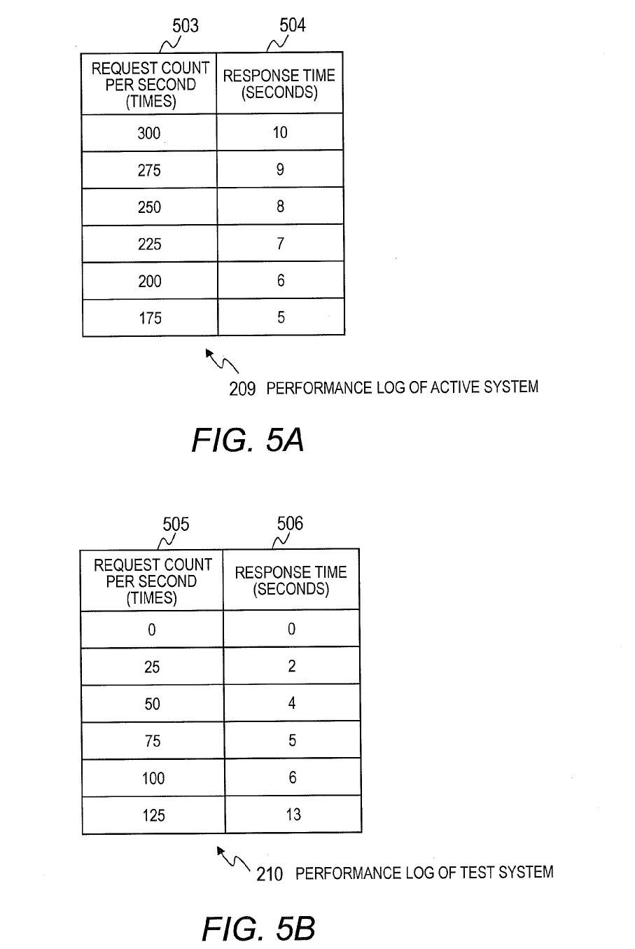

As shown in FIG. 5A, the performance log 209 of the active system includes a request count 503 per second and a response time 504. The request count 503 per second indicates the number of requests received per unit time by the load balancer 106. The response time 504 indicates a time period after the load balancer 106 receives the request from the end user terminal 103 before responding. It should be noted that this embodiment discusses an example in which one service is provided by the Web App servers 112-1 to 112-3, but when a plurality of services are provided, the performance log 209 of the active system can be generated for each service.

As shown in FIG. 5B, the performance log 210 of the test system is a performance log including a request count 505 per second and a response time 506 obtained during the performance test of the newly generated VM. The request count 505 per second and the response time 506 are the same as those of the performance log 209 of the active system shown in FIG. 5A.

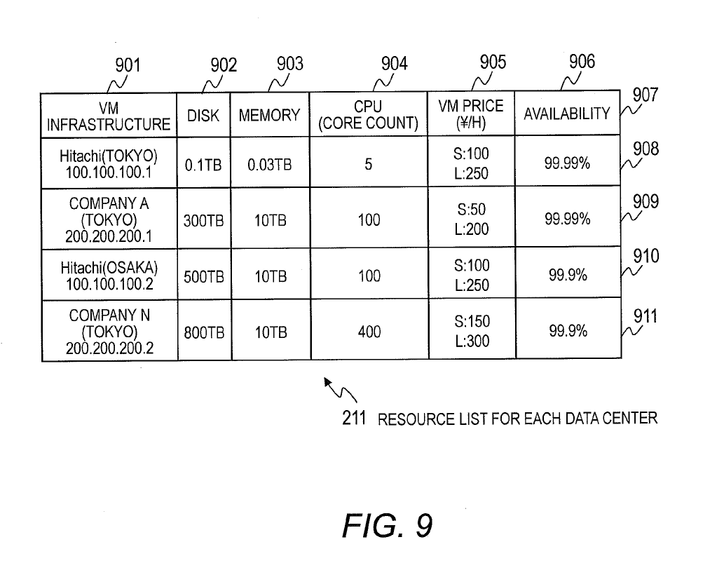

The resource list 211 includes, for each of the cloud systems 100 and 1000, information on computer resources such as an available CPU, a memory, a disk, and a usage fee. FIG. 9 is a table showing the resource list 211 for each data center.

The resource list 211 includes, in one entry, a VM infrastructure 901 for storing an identifier (name or IP address) of the cloud system 100 or the cloud infrastructure 101, a disk 902 for storing a storage capacity within the cloud infrastructure 101, a memory 903 for storing a capacity of a main memory within the cloud infrastructure 101, a CPU (core count) 904 for storing a core count of the CPU within the cloud infrastructure 101, a VM price (V/h) 905 for storing the usage fee of the virtual machine, and availability 906 for storing an operation rate of the cloud infrastructure 101.

Here, depending on a size of computer resources allocated by the cloud system 100, the VM price (¥/h) 905 stores the usage fee of the virtual machine per unit time for each of “Small (S)” indicating an allocation of the computer resource for a small-scale VM and “Large (L)” indicating an allocation of the computer resource 2.5 times as large as Small. It should be noted that the size of computer resources can be represented by a memory capacity, the storage capacity, the core count of the CPU, or the like. It should be noted that the VM infrastructure 901 may include the IP address of the resource pool.

It should be noted that, in the above-mentioned example, the size of computer resources is set stepwise by Small, Large, and the like, but may be represented by the core count of the CPU 1403, the memory capacity, or the like.

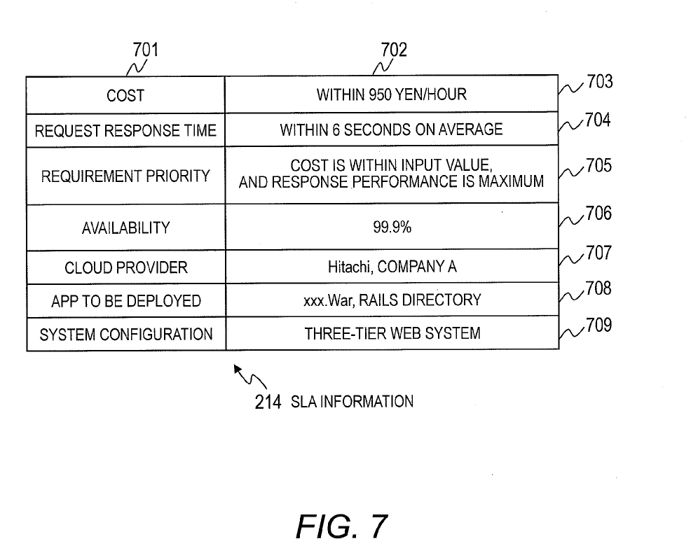

The SLA information 214 includes, as shown in FIG. 7, a cost 703, a request response time 704, a requirement priority 705, availability 706, a cloud provider 707, an app 708 to be deployed, and a system configuration 709 that are defined by an end user. The SLA information 214 is information or a condition set in advance by the app administrator terminal 116.

FIG. 7 is a table showing an example of the SLA information 214. The SLA information 214 includes fields of a requirement 701 and a detail 702 in one entry.

The cost 703 sets an upper limit to the usage fee per time contracted between the end user and the data center of the cloud system 100. The request response time 704 sets an allowable time period after the cloud system 100 receives the request before transmitting a response. The requirement priority 705 sets a requirement to be prioritized first and a requirement to be prioritized second among the requirements 701. The availability 706 sets the operation rate contracted between the end user and the cloud system 100. The cloud provider 707 sets the name of at least one available cloud provider. The app 708 to be deployed sets the application used by the end user and information relating to deployment of the application. The system configuration 709 sets details of the system used by the end user.

It should be noted that this embodiment discusses an example in which one end user uses the cloud system 100, but when the cloud system 100 provides the service to a plurality of end users, the SLA information 214 is set for each end user.

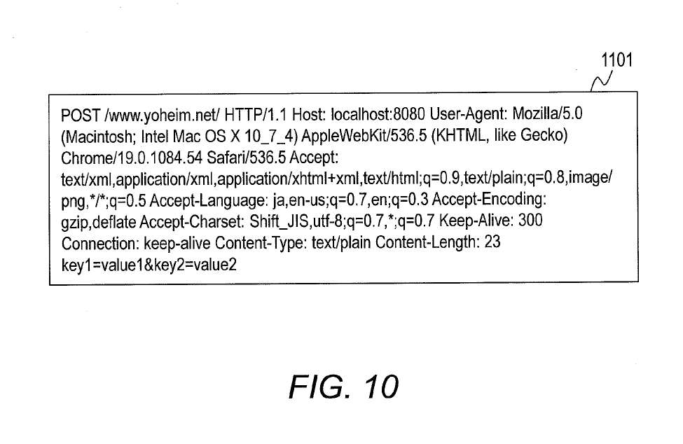

Next, the request pattern 215 is a set of accumulated requests transmitted to the cloud system 100 from the end user terminal 103 in the past. FIG. 10 is a diagram illustrating an example of the request. FIG. 10 illustrates an example of one POST request 1101. The HTTP request also includes a GET request.

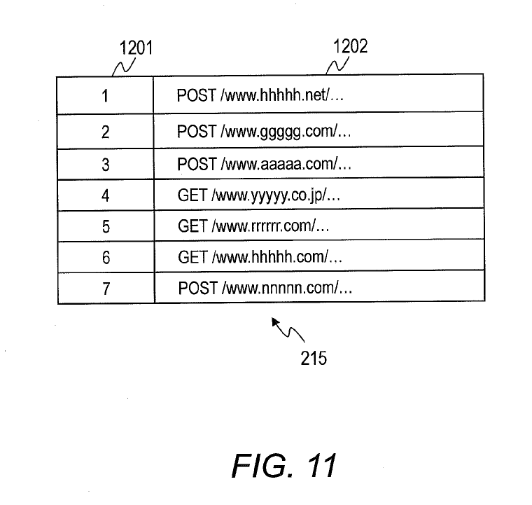

FIG. 11 is a table showing an example of the request pattern 215. The request pattern 215 includes a number 1201 and a request 1202 in one entry. The request 1202 includes a method of access and a URL.

The VM performance information 216 is performance information on the VM of the active cloud system 100, and includes a size and a response time for each VM.

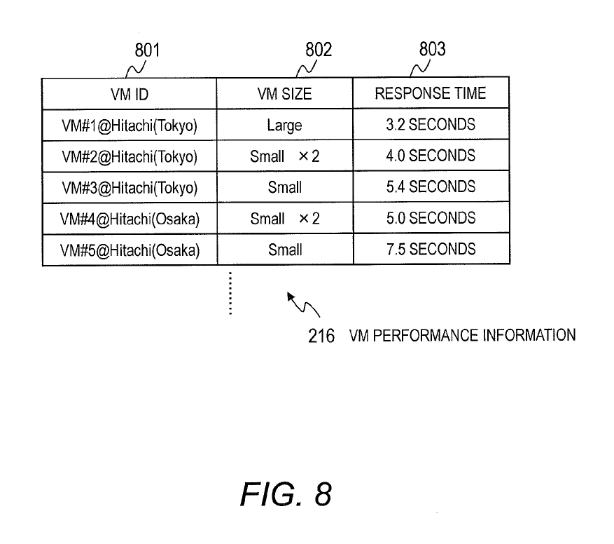

FIG. 8 is a table showing an example of the VM performance information 216. The VM performance information 216 includes a VM ID 801 for storing an identifier and a location of the VM, a VM size 802 for storing the scale of the VM, and a response time 803 for storing a time period after the load balancer 106 transmits the request before the VM receives the response.

In the same manner as the above-mentioned resource list 211, in regard to the VM size 802, assuming that the computer resource allocated to Small is 1, the computer resource allocated to Large is 2.5 times as large. Accordingly, (VM size 802)=Small×2 is a computer resource amount twice as large as Small. It should be noted that the VM performance information 216 is acquired by the management server 104 from the load balancer 106 at predetermined periods or the like, to be updated.

It should be noted that the control program 208 executed by the management server 104 has roughly four functions of the total control module 205, the log storage module 206, the DB management module 207, and the performance measurement module 220, but those functions may be distributed to and executed on separate servers.

FIG. 3 is a flowchart illustrating an example of processing for increasing the allocated computer resources executed by the management server 104.

In the cloud system 100, the Web App servers 112-1 to 112-3 provide a predetermined service to the end user terminal 103. The end user terminal 103 transmits a request to the service running on the Web App server 112, and the Web App server 112 sequentially processes the request and responds thereto.

The performance information such as the response time and the use status of the computer resource are constantly monitored by the load balancer 106 and the monitoring agents 22 of the VM#1 to the VM#3. The app administrator terminal 116 defines the SLA information 214 in advance and transmits the SLA information to the management server 104, and the SLA information is saved to the management server 104. The management server 104 acquires the performance information and the use status of the computer resource from each monitoring agent 22 at predetermined periods, and updates the performance log 209 of the active system.

When determining that a monitoring result received from the monitoring agent 22 of the load balancer 106 or the like does not satisfy the SLA information 214, the total control module 205 of the management server 104 starts the flowchart of FIG. 3, and adds the computer resource that satisfies the SLA information 214 to the Web App server 112 to be monitored. It should be noted that examples of a predetermined trigger at which the management server 104 starts the processing of FIG. 3 include a time when the service level of the SLA information 214 cannot be maintained while monitoring the performance log 209 of the active system and a time when an instruction is received from the cloud infrastructure administrator terminal 102.

In Step 301, the DB management module 207 of the management server 104 generates a snapshot of a storage area of the database 115. The generated snapshot may be stored in, for example, the storage 50.

In Step 302, it is determined whether or not there is a surplus in the computer resources in the cloud infrastructure 101 in which the total control module 205 of the management server 104 is currently running. This determination is made with reference to whether or not the total control module 205 can reserve, in the resource pool 118, computer resources equivalent to the computer resources allocated to the currently active Web App server 112. In the cloud infrastructure 101 in which the Web App server 112 is currently running, when sufficient computer resources cannot be reserved in the resource pool 118, the procedure advances to Step 303.

In Step 303, the total control module 205 selects, from the resource list 211, another cloud infrastructure in which the computer resources sufficient to generate the VM can be reserved in the resource pool. At this time, the total control module 205 refers to the resource list 211 indicating the computer resources available for each data center shown in FIG. 9. The resource list 211 is updated when the total control module 205 accesses each cloud provider and the data center at predetermined periods to acquire the information.

It should be noted that the cloud infrastructure selected by the total control module 205 may not be one, and a plurality of cloud infrastructures may be selected to reserve the computer resources different in latency or processing performance and generate the VM for the performance test.

When the computer resources are reserved in the cloud infrastructure for generating the VM for the test in Steps 302 and 303, the procedure advances to Step 304.

In Step 304, the total control module 205 and the performance measurement module 220 generate a plurality of VMs to which the computer resources reserved in Steps 302 and 303 are allocated, and execute the performance test.

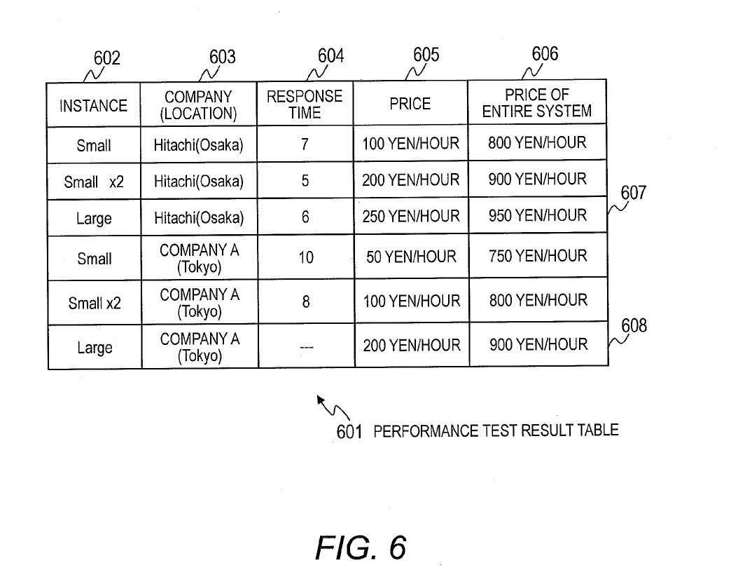

Here, the total control module 205 of the management server 104 generates a performance test result table 601 for each instance shown in FIG. 6.

For the sake of simplicity, it is assumed here that labels of Small and Large indicating the size of the instance (VM instance) defined for each cloud provider each indicate the same physical resource amount. In addition, the size Large is assumed to be the computer resource 2.5 times as large as that of Small. However, an instance name or a performance value of the computer resource differs for each cloud provider. It should be noted that a relationship between the response time and the VM size of the active Web App server 112 is acquired from the VM performance information 216 shown in FIG. 8.

In addition, by referring to the SLA information 214 and the performance log 209 of the active system, the total control module 205 can estimate an amount of requests to be processed by the computer resource to be added to the client system.

The total control module 205 can estimate from the estimated amount of requests how many computer resources (VMs) whose sizes are Small and Large are to be prepared. In other words, the total control module 205 determines the amount of computer resources whose allocation is to be changed for the computer resources allocated to the client system.

However, the request count that can be processed per unit time with the computer resources (VMs) whose sizes are Small and Large may be set in advance. The total control module 205 generates a list of the VM sets as the performance test result table 601 along with the above-mentioned estimation result and the information on each data center.

FIG. 6 is a table showing an example of the performance test result table 601 for each instance. The performance test result table 601 shown of FIG. 6 shows the list of the VM sets subjected to the test in order to add VMs to the active system (client system).

The performance test result table 601 includes, in one entry, an instance 602 for storing a kind of the instance, a location (company) 603 for storing a location of the cloud system that provides the instance and the cloud provider, a response time 604 for storing the response time (seconds) of the instance as the result of the performance test, a price 605 for storing the usage fee per unit time, and a price 606 of an entire system for storing the usage fee per unit time of the entire cloud system that is available.

Next, it is assumed that the cloud system 100 is formed of the VM#1, the VM#2, and the VM#3 shown in FIG. 8 and that 300 requests are being received every second as shown in the performance log 209 of the active system of FIG. 5A.

In addition, the total control module 205 refers to the resource list 211 of each data center shown in FIG. 9 and the SLA information 214 shown in FIG. 7. The total control module 205 refers to a row 704 of the SLA information 214 to acquire a definition that a request response time is within 6 seconds. By referring to the performance log 209 of the active system shown in FIG. 5A, the total control module 205 can determine that it is necessary to process 200 requests in the active system while processing the remaining 100 requests in another system (computer resource) in order to achieve the response time of 6 seconds.

Further, the cloud system 100 whose configuration has not been changed is running on the VM#1, the VM#2, and the VM#3 corresponding to Large=(1 machine) and Small=(3 machines) as shown in FIG. 8, the total control module 205 can determine that it is necessary to reserve Small=(2.25 machines) from an external computer resource. In other words, it is indicated that the Web App server 112 processes 200 requests by using 5.5 Small-equivalent computer resources and processes the remaining 100 requests by using 2.25 Small-equivalent computer resources.

As a method that allows the total control module 205 to reserve the computer resources corresponding to Small=(2.25 machines), it is possible to set Small=(1 machine), Small=(×2 machines), and Large=(1 machine) as a candidate considering an upper limit of the price indicated by the cost 703 in FIG. 7.

As a result, the total control module 205 acquires the available cloud provider from a row 707 of FIG. 7, and generates an entry of Small=(1 machine), Small=(×2 machines), and Large=(1 machine) in the instance 602 and the location 603 of the performance test result table 601 shown in FIG. 6 for each cloud provider. Further, the total control module 205 sets values of catalog information (not shown) in the price 605 and the price 606 of the entire system within FIG. 6.

In Step 304, the VM for the test is generated based on the performance test result table 601 generated by the total control module 205, and is subjected to the performance test. When the total control module 205 generates the VM for the test, a single VM set or a plurality of VM sets are generated and subjected to the test simultaneously. The performance measurement module 220 executes the same Web application 21 as in the client system, on the VM for the test, to conduct a trial run of the service. Then, the performance measurement module 220 measures the performance of the VM for the test which is conducting the trial run of the service.

In this embodiment, for example, as illustrated in FIGS. 1A and 1B, the VM set 109 for the test is generated from the resource pool 1010 in the total control module 205 and the cloud system 1000, which is a different cloud provider. Further, a VM set 405 for the test as illustrated in FIG. 4 is generated from the resource pool 118 also in the total control module 205 and the cloud system 100.

The cloud system 1000 of FIGS. 1A and 1B indicates scale out employed for the Web App server, and, for example, the VM sets 109 and 405 (not shown) are tested. The VMs 1112-1 and 1112-2 serving as one VM set 109 are registered in the load balancer 106 of the cloud system 100.

The performance measurement module 220 controls the generated VMs 1112-1 and 1112-2 to execute the Web application 21. The load balancer 106 copies the request addressed to the Web App server 112, and transmits the copied request to the VM 1112 for the test. The VM 1112 for the test receives the replication of the request from the load balancer 106, and the Web application 21 executes processing to conduct a trial run of the service of the client system. The performance measurement module 220 measures the performance of the VM 1112 for the test during a period of conducting the trial run of the service. In the measurement of the performance, the monitoring agent 22 of the load balancer 106 measures the response time of the VM for the test, and transmits the response time to the management server 104.

In Step 304, the VM sets 109 and 405 for the test may be subjected to the performance test in parallel with each other, but it is necessary to prevent the performance of the active system (Web App server 112) from being adversely affected. Therefore, in regard to the VM set to be subjected to the performance test, a start time is shifted by the performance measurement module 220, to thereby gradually raise the operation rate of the computer resources in the active system.

Then, the total control module 205 acquires the performance log from the monitoring agent 22 conducting the monitoring under its control, and constantly monitors the operation rate of the hardware computer resource in the active system and the performance of the cloud system 100, to thereby prevent the active system from being adversely affected.

When at least one of the VM sets 109 and 405 is generated, in Step 305, the total control module 205 selects an optimum VM set 109 that satisfies the SLA information 214 from among the results of the performance test for the VMs.

At a time point when the above-mentioned performance test result table 601 shown in FIG. 6 is generated, the response time 604 is undetermined, but after executing the above-mentioned performance test, the performance measurement module 220 can set the value in the response time 604. It should be noted that in FIG. 6, the VM of Company A corresponds to the VM set 109 illustrated in FIGS. 1A and 1B. The other VM set is generated as the VMs for the test (not shown) in the cloud system 100 (VM set 2).

In the performance test result table 601 shown in FIG. 6, the VM set (607) is selected as satisfying the cost in the SLA information 214 shown in FIG. 7, which is within 950 yen/hour and the request response time within 6 seconds. It should be noted that a row 608 of FIG. 6 indicates a case where the performance measurement module 220 does not measure the performance due to a possibility that deterioration may be caused in the performance of the active system (Web App server 112).

Here, the performance measurement module 220 generates the performance log 210 of the test system shown in FIG. 5B for each of the VM sets 109 and 405 subjected to the performance test. The performance log 209 of the active system shown in FIG. 5A is a table generated for the active Web App server 112.

Further, in Step 306, the VM (1112) selected by the total control module 205 is incorporated into the active system. At this time, the total control module 205 sets a ratio of distributing the requests for the added VM in the load balancer 106. In other words, the total control module 205 instructs the load balancer 106 to distribute ⅔ of the requests to the Web App server 112 of the cloud system 100 and distribute ⅓ of the requests to the Web App server 1112 of the cloud system 1000. Therefore, the total control module 205 adds the selected VM set to the client system, to dynamically apply a change in the computer resource.

When a plurality of VM sets for the test is generated in Step 304, the performance measurement module 220 deletes the VM sets other than the selected VM set for the test. Further, the snapshot of the database 115 used for the performance test is deleted by the total control module 205.

FIG. 4 is a sequence diagram illustrating an example of the performance test executed in Step 304. An instruction to generate a VM set is issued from the total control module 205 of the management server 104 to the resource pools 118 and 1010. It should be noted that the instruction to generate the VM set is transmitted to the hypervisors 20 of the resource pools 118 and 1010 running on the physical computer. At least one resource pool receives the instruction from the total control module 205. This embodiment discusses an example in which the VMs for the test are generated by the resource pool 118 of the cloud system 100 and the resource pool 1010 of the cloud system 100.

The hypervisors 20 of the resource pools 118 and 1010 each receive the instruction to generate at least one VM set, and generates the VM sets 109 and 405 to be tested from a VM image set in advance.

FIG. 4 illustrates a case where two VM sets 109 and 405 are generated, but the number of VM sets is not limited to 2.

In FIGS. 1A and 1B, not only the VM set 117 in the active system but also the VM set 405 for the test and the VM set 109 for the test in the cloud system 1000 are generated, and the cloud infrastructure 101 and the cloud infrastructure 1003 are coupled to each other. This example particularly indicates the scale out on the Web App server, and the VMs 1112-1 and 1112-2 for the test are added to the load balancer 106 as candidates for the Web App server. It should be noted that the VM set 405 shown in FIG. 4 is not shown in FIGS. 1A and 1B.

When receiving the instruction to generate the VM, the hypervisors of the resource pools 118 and 1010 transmits a VM generation reception notification to the total control module 205 of the management server 104. After that, the performance measurement module 220 of the management server 104 instructs the load balancer 106 to impose load on the VM sets 109 and 405. At this time, the load balancer 106 copies the request addressed to the active system, and transmits the replication of the request to the VM sets 109 and 405.

The load balancer 106 receives responses from the VM sets 109 and 405, and transmits the measurement results such as the response time to the performance measurement module 220 of the management server 104. The total control module 205 of the management server 104 selects the optimum VM set 109 tested from the measurement results as described above, and instructs the resource pool 118 to delete the other VM sets 405 to be tested. Then, the total control module 205 adds the selected VM set 109 to the active system (client system).

In the above-mentioned performance test illustrated in FIG. 4, for example, the load balancer 106 transmits the copy of the request to the VM for the test to execute the performance test in parallel with the active system, but the input data for the performance test is not limited to the copy of the request.

The performance measurement module 220 of the management server 104 may transmit the past request accumulated in the request pattern 215 to the VM sets 109 and 405 for the test, to thereby execute the performance test.

In this case, first, the total control module 205 outputs the instruction to start imposing the load to the performance measurement module 220. Subsequently, the performance measurement module 220 transmits the request to the load balancer 106, and the load balancer 106 distributes the requests to the VM sets 109 and 405.

In this example, the load balancer 106 does not need to have a function of copying the request. A plurality of ports or a plurality of IP addresses are set in the load balancer 106 so that the request received at a first port or a first IP address is distributed to the active system and that the request received at a second port or a second IP address is distributed to the VM set subjected to the performance test.

The function of copying the request implemented by the above-mentioned load balancer 106 can be substituted by a switch by placing the switch between the load balancer 106 and the end user terminal 103.

FIG. 5A is a table showing an example of the performance log of the active system. FIG. 5B is a table showing an example of the performance log of the VM set to be tested.

When the VM set 109 to be tested is added to the active system, the management server 104 determines a ratio of load on the active system and the VM set 109 to be tested to be added, and estimates whether or not responsiveness can be ensured throughout the entire system after the VM is added.

The performance log 209 of the active system is a table in which the performance information relating to the active system is recorded. The performance log 209 of the active system shows the performance of the active system, and is a table generated after the operation starts.

The request count 503 per second within the performance log 209 of the active system stores the number of requests received from the end user terminal 103 or a value representing the load imposed on the system. The response time 504 represents the average response time or the information relating to the performance.

The performance log 210 of the test system is a table of the performance relating to the VM set to be tested. The performance log 210 of the test system is a table generated after the performance test starts. The request count 505 per second stores the request count or a value representing an amount of load imposed on the system in the same manner as the request count 503 per second. The response time 506 is a column representing the response time or the information relating to the performance in the same manner as the response time 504.

FIG. 13 is a screen image illustrating an example of the input screen 2140 of the SLA information 214. The input screen 2140 is provided to the app administrator terminal 116 by the management server 104. The input screen 2140 illustrated in FIG. 13 has the same format as the SLA information 214 shown in FIG. 7.

The input screen 2140 includes fields of a requirement 2141 and a detail 2142 in one entry. A cost 2143 sets an upper limit to the usage fee per time. A request response time 2144 sets an allowable time period after the cloud system 100 receives the request before a Web App 21 outputs a response. A requirement priority 2145 sets a requirement to be prioritized first and a requirement to be prioritized second among the requirements 2141. Availability 2146 sets the operation rate contracted between the end user and the cloud system 100. A cloud provider 2147 sets the name of at least one available cloud provider. An app 2148 to be deployed sets the application used by the end user and information relating to deployment of the application. A system configuration 2149 sets details of the system used by the end user.

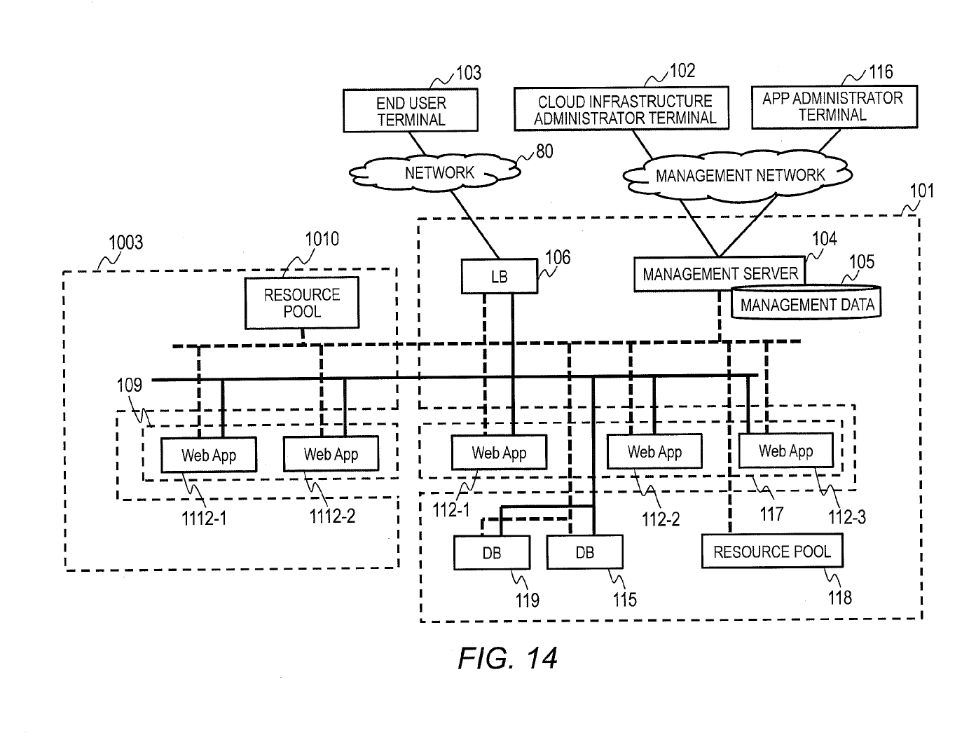

FIG. 14 illustrates a modification example of the first embodiment, and is a block diagram illustrating an example of functions of the cloud system.

In FIG. 14, the management server 104 generates a replica 119 of the database 115, and generates a snapshot corresponding to the replica. Then, the VM set 109 for the test uses the snapshot of the replica 119 to execute the performance test. In this case, an influence on the active system becomes smaller than in a case where the replica 119 is not used.

According to the above-mentioned processing, when determining that the SLA information 214 cannot be satisfied by referring to the performance log 209 of the active system, the management server 104 determines the computer resource amount that satisfies the SLA information 214, and generates the VM corresponding to the computer resource amount to execute the performance test. When determining that the SLA information 214 can be satisfied by the performance test, the management server 104 adds the computer resource to a currently active client system.

Therefore, the computer resource can be allocated to the client system (virtual machine group) in accordance with the actual performance instead of catalog performance of the cloud system 100. Then, in the cloud system 100, an appropriate computer resource can be provided by guaranteeing the performance of the client system and suppressing such reduction in the performance as seen in the related-art example. Further, as the computer resource to be added to the client system, the management server 104 automatically calculates the optimum amount of computer resources (VM size or amount), and generates the VM including the computer resource corresponding to a calculation result thereof. Then, the management server 104 executes the performance test for the generated VM, and as a result of the performance test, the service level of the SLA information 214 can be guaranteed by selecting the VM that satisfies the SLA information 214. Therefore, it is possible to efficiently control the computer resource to be allocated to the client system for providing the service in the cloud system 100.

### Second Embodiment

In the first embodiment, the example of increasing the computer resources by scaling out the client system of the cloud system 100 is described. In a second embodiment of this invention, an example in which the computer resource is released when the client system of the cloud system 100 holds an excessive amount of computer resources is described. It should be noted that the configurations of the cloud system 100 and the like are the same as those of the first embodiment.

The management server 104 refers to the performance log 209 of the active system, and in a case where the performance of the client system excessively satisfies the SLA information 214 set by the app administrator terminal 116, deletes the VM that satisfies the SLA information 214 by gradually releasing the load of the VM allocated to the Web App server 112, to reduce the active system. The case where the SLA information 214 is excessively satisfied is a case where an excessive amount of computer resources is allocated, and examples thereof include a case where the response time is 3 seconds on average when the request response time 704 is 6 seconds.

It should be noted that the case where the performance of the client system excessively satisfies the SLA information 214 represents a case where the performance exceeds a predetermined threshold value, for example, is at least twice as large as the performance condition set by the SLA information 214.

FIG. 8 shows the VM performance information 216 for each active VM. In FIG. 8, the VM#1 to the VM#3 whose location indicated by the VM ID 801 is Tokyo correspond to the Web App servers 112-1 to 112-3 illustrated in FIGS. 1A and 1B, and a VM#4 and a VM#5 within FIG. 8 correspond to the virtual machines 1112-1 and 1112-2 in the cloud system 1000.

The total control module 205 selects the VM#5 (1112-2) having the longest response time in the response time 803. Subsequently, the total control module 205 changes settings of the function of distributing the requests by the load balancer 106, and gradually reduces the requests addressed to the VM#5. Then, the total control module 205 determines whether or not the distribution of the requests addressed to the VM#5 can be fully stopped.

It should be noted that as a method of gradually reducing the requests addressed to the VM#5, the load balancer 106 may release the load on the VM#5 by reducing the request by a predetermined number at predetermined periods (for example, 5 seconds) so as to finally reach the request count of 0.

In regard to this determination, the total control module 205 determines whether or not the SLA information 214 can be satisfied even when the request addressed to the VM#5 (virtual machine 1112-2) functioning as the Web App server is processed by another VM.

In the course of gradually reducing the requests addressed to the VM#5, the total control module 205 monitors the response time of the active system, and when the SLA information 214 is not satisfied, stops an attempt to delete the VM.

When the SLA information 214 remains satisfied until the distribution of the requests addressed to the VM#5 is fully stopped, the total control module 205 transmits an instruction to delete the VM#5 to the hypervisor of the cloud infrastructure 1003.

In regard to the VM#4 (Web App server 112-1), the total control module 205 subsequently attempts to delete the VM#4 in the same manner as described above. When the SLA information 214 is no longer satisfied, the total control module 205 cancels the deletion of the VM#4, and returns to such distribution of the requests as to maximize the performance in the currently active system.

According to the above-mentioned processing, the management server 104 refers to the performance log 209 of the active system (client system), and in a case where the performance that surpasses the SLA information 214 is granted, deletes the VM having the longest response time (lowest performance). At this time, while gradually reducing the number of requests transmitted to the VM to be deleted, the management server 104 monitors whether or not the SLA information 214 is satisfied throughout the entire active system. The management server 104 gradually reduces the request count by reducing the request count per unit time by a predetermined number. When the SLA information 214 is satisfied even when the request addressed to the VM to be deleted is stopped, the management server 104 can delete the VM to return the computer resource of the VM to the resource pools 118 and 1010.

According to the above-mentioned processing, it is possible to dynamically increase or decrease the allocation of the computer resource while satisfying the SLA information 214 of the active system.

Further, in regard to the dynamically changing computer resource, the management server 104 automatically calculates the optimum amount of computer resources, and guarantees the service level of the SLA information 214 based on the performance test. Therefore, it is possible to efficiently automate the allocation of the computer resource of the cloud system 100.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD.

The control lines and information lines described are lines that are deemed necessary for the description of this invention, and not all of control lines and information lines of a product are mentioned. In actuality, it can be considered that almost all components are coupled to one another.

What is claimed is:

1. A method of allocating a computer resource, for dynamically changing a virtual machine group in a computer system,
the computer system comprising:
a physical computer comprising a processor and a memory;
a virtualization module for allocating a computer resource of the physical computer to a virtual machine;
a management computer for controlling the virtual machine group of at least one virtual machine for providing a service,
the method comprising:
a first step of acquiring, by the management computer, performance of the virtual machine group for providing the service;
a second step of comparing, by the management computer, the acquired performance of the virtual machine group with a performance condition for the service set in advance;
a third step of determining, by the management computer, the computer resource to be changed within the virtual machine group in accordance with a result of the comparison;
a fourth step of measuring, by the management computer, performance of the virtual machine by conducting a trial run of the service on the virtual machine corresponding to the computer resource to be changed;
a fifth step of determining, by the management computer, whether or not the measured performance satisfies the performance condition for the service; and
a sixth step of applying, by the management computer, the change when the measured performance satisfies the performance condition for the service.

2. The method of allocating a computer resource according to claim 1, wherein:
the third step comprises determining the computer resource to be added to the virtual machine group when the comparison result indicates that the performance of the virtual machine group does not satisfy the performance condition for the service;
the fourth step comprises:
generating a virtual machine for a test corresponding to the determined computer resource;
conducting the trial run of the service on the virtual machine for the test; and
measuring the performance of the virtual machine for the test; and
the sixth step comprises adding the virtual machine for the test to the virtual machine group when the measured performance of the virtual machine for the test satisfies the performance condition for the service.

3. The method of allocating a computer resource according to claim 1, wherein:
the third step comprises determining the computer resource to be added to the virtual machine group when the comparison result indicates that the performance of the virtual machine group does not satisfy the performance condition for the service;
the fourth step comprises:
generating a plurality of virtual machines for a test corresponding to the determined computer resource;
conducting the trial run of the service on each of the plurality of virtual machines for the test; and
measuring the performance of the each of the plurality of virtual machines for the test; and
the sixth step comprises selecting the virtual machine for the test, the measured performance of which satisfies the performance condition for the service from among the plurality of virtual machines for the test, to add the selected virtual machine for the test to the virtual machine group.

4. The method of allocating a computer resource according to claim 3, wherein the fourth step further comprises generating the virtual machine for the test corresponding to the determined computer resource in each of the computer system and another computer system.

5. The method of allocating a computer resource according to claim 1, wherein:
the computer system further comprises a load balancer for distributing a request to the virtual machine group; and
the fourth step comprises instructing, by the management computer, the load balancer to transmit a replication of the request to the virtual machine corresponding to the computer resource to be changed and to control the virtual machine to execute processing corresponding to the request.

6. The method of allocating a computer resource according to claim 1, wherein:
the computer system further comprises a load balancer for distributing a request to the virtual machine group; and
the fourth step comprises acquiring, by the management computer, the request from the load balancer, accumulating the request, transmitting the accumulated request to the virtual machine corresponding to the computer resource to be changed, and controlling the virtual machine to execute processing corresponding to the request.

7. The method of allocating a computer resource according to claim 1, wherein:
the computer system further comprises a database used by the service; and
the fourth step comprises:
generating a snapshot of the database; and
conducting the trial run of the service by using the snapshot on the virtual machine corresponding to the computer resource to be changed, to measure the performance of the virtual machine.

8. The method of allocating a computer resource according to claim 1, wherein:
the computer system further comprises a database used by the service and a replica of the database; and
the fourth step comprises:
generating a snapshot of the replica; and
conducting the trial run of the service by using the snapshot on the virtual machine corresponding to the computer resource to be changed, to measure the performance of the virtual machine.

9. The method of allocating a computer resource according to claim 1, wherein:
the third step comprises determining the computer resource to be deleted from the virtual machine group when the comparison result indicates that the performance of the virtual machine group exceeds the performance condition for the service by a predetermined threshold value;
the fourth step comprises:
conducting the trial run of the service by gradually releasing load on the virtual machine corresponding to the determined computer resource; and
measuring the performance of the virtual machine group; and
the sixth step comprises deleting the virtual machine from the virtual machine group when the performance of the virtual machine group satisfies the performance condition for the service.

10. A computer system, comprising:
a physical computer comprising a processor and a memory;
a virtualization module for allocating a computer resource of the physical computer to a virtual machine;
a management computer for controlling a virtual machine group of at least one virtual machine for providing a service,
the management computer comprising:
a control module configured to:
acquire performance of the virtual machine group for providing the service;
compare the acquired performance of the virtual machine group with a performance condition for the service set in advance; and
determine the computer resource to be changed within the virtual machine group in accordance with a result of the comparison; and
a performance measurement module for measuring performance of the virtual machine by conducting a trial run of the service on the virtual machine corresponding to the computer resource to be changed,
wherein the control module applies the change when the measured performance satisfies the performance condition for the service.

11. The computer system according to claim 10, wherein:
the control module is further configured to:
determine the computer resource to be added to the virtual machine group when the comparison result indicates that the performance of the virtual machine group does not satisfy the performance condition for the service; and
generate a virtual machine for a test corresponding to the determined computer resource;
the performance measurement module is further configured to:
conduct the trial run of the service on the virtual machine for the test; and
measure the performance of the virtual machine for the test; and
the control module is further configured to add the virtual machine for the test to the virtual machine group when the measured performance of the virtual machine for the test satisfies the performance condition for the service.

12. The computer system according to claim 10, wherein:
the control module is further configured to:
determine the computer resource to be added to the virtual machine group when the comparison result indicates that the performance of the virtual machine group does not satisfy the performance condition for the service; and
generate a plurality of virtual machines for a test corresponding to the determined computer resource;
the performance measurement module is further configured to:
conduct the trial run of the service on each of the plurality of virtual machines for the test; and
measure the performance of the each of the plurality of virtual machines for the test; and
the control module is further configured to select the virtual machine for the test, the measured performance of which satisfies the performance condition for the service from among the plurality of virtual machines for the test, to add the selected virtual machine for the test to the virtual machine group.

13. The computer system according to claim 12, wherein the control module is further configured to generate the virtual machine for the test corresponding to the determined computer resource in each of the computer system and another computer system.

14. The computer system according to claim 10, wherein:
the computer system further comprises a load balancer for distributing a request to the virtual machine group; and
the control module is further configured to instruct the load balancer to transmit a replication of the request to the virtual machine corresponding to the computer resource to be changed and to control the virtual machine to execute processing corresponding to the request.

15. The computer system according to claim 10, wherein:
the computer system further comprises a load balancer for distributing a request to the virtual machine group; and
the control module is further configured to acquire the request from the load balancer, accumulate the request, transmit the accumulated request to the virtual machine corresponding to the computer resource to be changed, and control the virtual machine to execute processing corresponding to the request.
